(19) United States
(12) Patent Application Publication
(10) Pub. No.: US 2019/0266878 A1
(43) Pub. Date: Aug. 29, 2019

(54) VEHICLE-MOUNTED DEVICE, NOTIFICATION SYSTEM, AND NOTIFICATION METHOD

(71) Applicant: MITSUBISHI ELECTRIC CORPORATION, Tokyo (JP)

(72) Inventor: Masahiro NAKATSUKASA, Tokyo (JP)

(73) Assignee: MITSUBISHI ELECTRIC CORPORATION, Tokyo (JP)

(21) Appl. No.: 16/341,356

(22) PCT Filed: Nov. 7, 2016
(86) PCT No.: PCT/JP2016/082965

§ 371 Date: Apr. 11, 2019

(51) Int. Cl. G08B 21/24; H04W 4/02; H04W 4/44; H04M 1/725

(52) U.S. Cl. CPC G08B 21/24; H04W 4/023; H04M 1/72572; H04M 1/7253; H04W 4/44

(57) ABSTRACT

When it is determined by a determining unit that there is a wireless communication terminal mislaid in a vehicle cabin, out of wireless communication terminals, a control unit selects a wireless communication method from among different multiple wireless communication methods depending on the degrees that the wireless communication terminals move away from the vehicle. A wireless communication unit can perform wireless communications while switching to each of the multiple wireless communication methods, and transmits notification information about the mislaying to a wireless communication terminal outside the vehicle cabin via wireless communications using the wireless communication method selected by the control unit.

### TECHNICAL FIELD

The present invention relates to a vehicle-mounted device for, a notification system for, and a notification method of notifying an alighting person that there is a wireless communication terminal mislaid in a vehicle cabin.

### BACKGROUND ART

Conventionally, a technique of notifying an alighting person that there is a wireless communication terminal mislaid in a vehicle cabin has been proposed. For example, a vehicle-mounted device described in Patent Literature 1 detects whether or not a mobile phone has been carried outside a vehicle cabin by monitoring the electric field strength at a time of performing short-range wireless communications with multiple mobile phones carried inside the vehicle cabin. Then, when detecting a mobile phone left in the vehicle cabin after all the occupants of the vehicle have alighted, this vehicle-mounted device notifies another mobile phone which is detected as having been carried outside the vehicle cabin that there is the mobile phone left in the vehicle cabin.

### CITATION LIST

### Patent Literature

Patent Literature 1: Japanese Unexamined Patent Application Publication No. 2005-277499

### SUMMARY INVENTION

### Technical Problem

However, the vehicle-mounted device described in Patent Literature 1 is premised on mobile phones that can perform specific short-range wireless communications, and thus there is a problem that a mobile phone that cannot perform the short-range wireless communications cannot be notified of mislaying.

In addition, because only a mobile phone that can perform specific short-range wireless communications is notified of mislaying, there is a possibility that when the mobile phone is in a state in which the mobile phone is contained in a bag or the like, an alighting person is unable to notice a notification of the mislaying, in the vicinity of the vehicle.

The present invention is made in order to solve the above-mentioned problem, and it is therefore an object of the present invention to provide a vehicle-mounted device, a notification system, and a notification method capable of increasing the opportunity to provide a notification of the mislaying of a wireless communication terminal.

### Solution to Problem

A vehicle-mounted device according to the present invention includes an estimating unit, an alighting detecting unit, a determining unit, a wireless communication unit, and a control unit. The estimating unit estimates degrees that respective one or more wireless communication terminals move away from a vehicle. The alighting detecting unit detects alighting of an occupant of the vehicle. When alighting of the occupant is detected by the alighting detecting unit, the determining unit determines whether or not there is a wireless communication terminal mislaid in a vehicle cabin of the vehicle, out of the wireless communication terminals whose degrees that the respective wireless communication terminals move away from the vehicle are estimated by the estimating unit. The wireless communication unit can perform wireless communications while switching among different multiple wireless communication methods, and, when it is determined by the determining unit that there is a wireless communication terminal mislaid in the vehicle cabin, transmits notification information about the mislaying to a wireless communication terminal outside the vehicle cabin via wireless communications using a wireless communication method selected from among the multiple wireless communication methods. The control unit selects one of the wireless communication methods at a time when the wireless communication unit transmits the notification information, depending on the degrees that the respective wireless communication terminals move away from the vehicle, the degrees being estimated by the estimating unit.

### Advantageous Effects of Invention

According to the present invention, because mislaying of a wireless communication terminal is notified via wireless communications using a wireless communication method selected from among the multiple wireless communication methods, the opportunity to provide a notification of the mislaying can be increased.

### BRIEF DESCRIPTION OF DRAWINGS

FIG. 1 is a block diagram showing the configuration of a vehicle-mounted device according to Embodiment 1 of the present invention;

FIG. 2 is a graph showing a relation between the reception level of a signal received from a wireless communication terminal, and the distance between the wireless communication terminal and a vehicle;

FIG. 3 is a block diagram showing the configuration of a wireless communication terminal in Embodiment 1;

FIG. 4A is a block diagram showing an example of a hardware configuration for implementing the functions of the vehicle-mounted device according to Embodiment 1;

FIG. 4B is a block diagram showing an example of a hardware configuration for executing software to implement the functions of the vehicle-mounted device according to Embodiment 1;

FIG. 5 is a flowchart showing the operation of the vehicle-mounted device according to Embodiment 1;

FIG. 6 is a flowchart showing the operation of the wireless communication terminal in Embodiment 1; and

FIG. 7 is a diagram showing a summary of a process of providing a notification of the mislaying of a wireless communication terminal in Embodiment 1.

### DESCRIPTION OF EMBODIMENTS

Hereafter, in order to explain the present invention in greater detail, embodiments of the present invention will be described with reference to the accompanying drawings.

### Embodiment 1

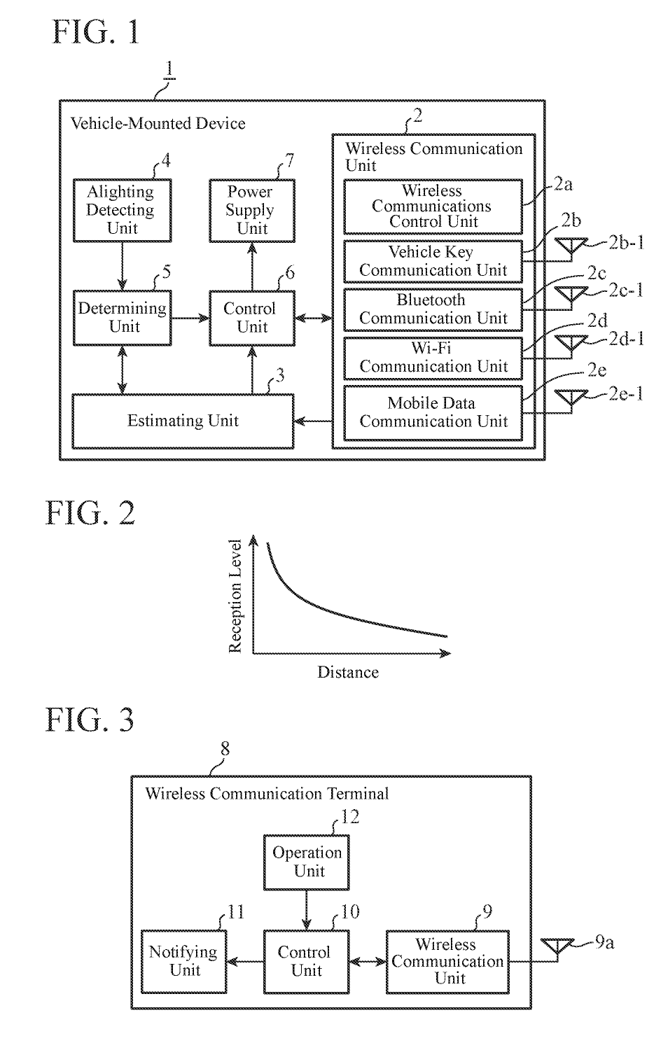

FIG. 1 is a block diagram showing the configuration of a vehicle-mounted device 1 according to Embodiment 1 of the present invention.

The vehicle-mounted device 1 is implemented by a car navigation device or the like, and includes a wireless communication unit 2, an estimating unit 3, an alighting detecting unit 4, a determining unit 5, a control unit 6, and a power supply unit 7.

The wireless communication unit 2 is a component that can perform wireless communications by using each of multiple wireless communication methods. As the wireless communication methods, for example, vehicle key communications, Bluetooth (registered trademark, and this description will be omitted hereafter), Wi-Fi (Wireless Fidelity), and mobile data communications are provided.

The vehicle key communications include keyless entry wireless, and the mobile data communications include LTE (Long Term Evolution), 4G (4th Generation), and 3G (3rd Generation).

As wireless communication methods with each of which the wireless communication unit 2 can perform wireless communications, a wireless LAN (Local Area Network), DSRC (Dedicated Short Range Communication), vehicle-to-vehicle wireless, road-to-vehicle wireless, and pedestrian-to-vehicle wireless can be included.

The wireless communication unit 2 includes a wireless communications control unit 2a, a vehicle key communication unit 2b, a Bluetooth communication unit 2c, a Wi-Fi communication unit 2d, and a mobile data communication unit 2e.

The wireless communications control unit 2a controls switching to select a communication unit that performs wireless communications from among the vehicle key communication unit 2b, the Bluetooth communication unit 2c, the Wi-Fi communication unit 2d, and the mobile data communication unit 2e.

For example, the wireless communications control unit 2a switches to a communication unit corresponding to a wireless communication method selected by the control unit 6, as the communication unit that performs wireless communications.

The vehicle key communication unit 2b performs wireless communications, via an antenna 2b-1, with a vehicle key. The Bluetooth communication unit 2c performs wireless communications, via an antenna 2c-1, with a wireless communication terminal that can perform Bluetooth communications. The Wi-Fi communication unit 2d performs wireless communications, via an antenna 2d-1, with a wireless communication terminal that can perform Wi-Fi communications. The mobile data communication unit 2e performs wireless communications, via an antenna 2e-1, with a wireless communication terminal that can perform mobile data communications.

The estimating unit 3 estimates the degree that a wireless communication terminal moves away from the vehicle. The degree that a wireless communication terminal moves away from the vehicle can be expressed by, for example, the distance between the wireless communication terminal and the vehicle. As a method of estimating the distance, there are methods (1) and (2) mentioned below. Basically, the above-mentioned distance is estimated by using the method (1), and, when the method (2) is possible, higher priority is given to the distance derived using the method (2).

### 1. Method (1)

First, the estimating unit 3 stores data as shown in FIG. 2, the data showing a relation between the reception level of a signal received from a wireless communication terminal, and the distance between the wireless communication terminal and the vehicle. Because used frequencies, transmission power, the characteristics of the antenna, and so on differ dependently upon the wireless communication method for use in a wireless communication terminal, the estimating unit 3 stores the relation between the above-mentioned reception level and the above-mentioned distance for each of the multiple wireless communication methods. Then, the estimating unit 3 receives the reception level of an electric wave which each of the communication units for the respective multiple wireless communication methods in the wireless communication unit 2 has received from a corresponding wireless communication terminal, compares the reception level inputted thereto and the data shown in FIG. 2, and estimates the distance between the wireless communication terminal and the vehicle.

### 2. Method (2)

Although not illustrated in FIG. 1, when a wireless communication terminal and the vehicle-mounted device 1 include position detecting devices using GPS (Global Positioning System) or the like, the estimating unit 3 estimates the distance between the wireless communication terminal and the vehicle by using both position information about the wireless communication terminal, the position information being received by the wireless communication unit 2, and position information detected by the position detecting device of the vehicle-mounted device 1.

The degree that a wireless communication terminal moves away from the vehicle is not limited to the distance between the wireless communication terminal and the vehicle.

For example, as shown in FIG. 2, the reception level of a signal received from a wireless communication terminal varies depending on the distance between the wireless communication terminal and the vehicle. Therefore, the degree that the wireless communication terminal moves away from the vehicle can be expressed by the magnitude of the reception level.

As an alternative, the degree that the wireless communication terminal moves away from the vehicle can be expressed by an index value which is a combination of the reception level of a signal received from the wireless communication terminal, and a time which has elapsed since an occupant of the vehicle has alighted.

The alighting detecting unit 4 detects the alighting of an occupant of the vehicle. For example, the alighting detecting unit 4 acquires vehicle information from a vehicle control device that performs engine control, door opening and closing control, and so on, and detects the alighting of an occupant on the basis of the vehicle information acquired thereby.

As the vehicle information, information indicating the switching on or off of an ignition key switch, information indicating the opening and closing of a door, and information indicating the locking or unlocking of a door can be provided. In this case, when the door is locked after the ignition key switch of the vehicle has been switched off, the alighting detecting unit 4 determines that an occupant has alighted. Further, in a case in which a vehicle-mounted camera is mounted, when the ignition key switch of the vehicle has been switched off and, after that, an image recognition result of an image shot by the vehicle-mounted camera shows that there is no longer any occupant in the vehicle cabin, the alighting detecting unit 4 determines that an occupant has alighted.

Further, the opening or closing of a vehicle window, the presence or absence of an occupant, the seat position of each occupant, and the number of occupants can be included in the vehicle information, and the alighting of only an occupant who has sat down on a specific seat in the vehicle cabin can be detected.

For example, in order to prevent mislaying in a taxi, when a human-sensing sensor disposed in the rear seat or the front seat next to the driver no longer detects any person after a door has been opened and closed, the alighting detecting unit 4 determines that a customer of the taxi has alighted.

When the alighting of an occupant is detected by the alighting detecting unit 4, the determining unit 5 determines whether or not there is a wireless communication terminal mislaid in the vehicle cabin, out of wireless communication terminals as to which the degrees that the wireless communication terminals move away from the vehicle are estimated by the estimating unit 3.

For example, in the case in which the degree that each wireless communication terminal moves away from the vehicle is the distance between the corresponding wireless communication terminal and the vehicle, there may exist a wireless communication terminal whose distance from the vehicle has changed and a wireless communication terminal whose distance from the vehicle has not changed when an occupant has alighted. The determining unit 5 determines that a wireless communication terminal whose distance from the vehicle has not changed is one mislaid in the vehicle cabin. The distance from the vehicle-mounted device 1 to a door of the vehicle is set as a threshold, and it is determined that a wireless communication terminal existing in a range which does not exceed this threshold is one whose distance from the vehicle has not changed.

As a result, even when a vehicle key is mislaid in the vehicle cabin, a wireless communication terminal outside the vehicle cabin can be notified of the mislaying and the vehicle key can be prevented from having been mislaid.

The control unit 6 selects a wireless communication method at the time that the wireless communication unit 2 transmits notification information, depending on the degrees that the wireless communication terminals move away from the vehicle, the degrees being estimated by the estimating unit 3.

For example, when receiving a notification indicating the mislaying of a wireless communication terminal from the determining unit 5, the control unit 6 first selects the vehicle key communications from among the multiple wireless communication methods, and outputs both an instruction to switch the wireless communication method to the vehicle key communications and the notification information about the mislaying to the wireless communications control unit 2a.

The wireless communications control unit 2a switches to the vehicle key communication unit 2b in accordance with the instruction from the control unit 6, and the vehicle key communication unit 2b transmits the notification information to the vehicle key. As a result, the driver who has alighted can be promptly notified of the mislaying of the wireless communication terminal.

While the notification information is transmitted to the vehicle key, the control unit 6 acquires the degree that another wireless communication terminal moves away from the vehicle, the degree being estimated by the estimating unit 3, e.g., data about the distance.

Next, the control unit 6 selects a wireless communication method corresponding to the above-mentioned distance, and outputs both an instruction to switch to the selected wireless communication method and the notification information about the mislaying to the wireless communications control unit 2a. The wireless communications control unit 2a switches the communication unit at the time of transmitting the notification information to the communication unit using the wireless communication method selected by the control unit 6. As a result, the communication unit using the wireless communication method selected by the control unit 6 transmits the notification information to a wireless communication terminal which can perform wireless communications using the selected wireless communication method.

The descriptions of the notification information include information reporting the mislaying of a wireless communication terminal, and specific information about the wireless communication terminal. As the specific information about the wireless communication terminal, at least one of identification information such as the model name of the wireless communication terminal, owner information, and a phone number is provided, and, for example, when the wireless communication terminal is carried into the vehicle cabin, the vehicle-mounted device 1 can acquire the specific information. Further, when the notification destination is the vehicle key, an alarm sound such as a beep can be provided.

The above-mentioned distance serving as a criterion used for selecting a wireless communication method is not a maximum distance range in which communications can be performed, but can be appropriately set in the vehicle-mounted device 1.

The distance at which the switching of a wireless communication method is performed can be set appropriately.

For example, the switching of a wireless communication method is performed in such a way that the vehicle key is selected within a distance range up to 1 m from the vehicle, Bluetooth is selected within a distance range from 1 m to 3 m, Wi-Fi is selected within a distance range from 3 m to 5 m, and mobile data communications are selected within a distance range of 5 m or more.

The types of wireless communication terminals each of which is to be notified are selected in descending order of probability that the alighting person is carrying. When the alighting person is the driver, the notification information is transmitted to the vehicle key with high probability that the vehicle key is carried by the alighting person, and is then transmitted to a Bluetooth-compliant or Wi-Fi-compliant terminal with a high penetration rate. After that, the notification information can be transmitted using other wireless communications, such as vehicle-to-vehicle wireless, road-to-vehicle wireless, or pedestrian-to-vehicle wireless.

Further, the control unit 6 instructs the power supply unit 7 to stop the power supply to the vehicle-mounted device 1.

For example, when receiving a notification indicating that no mislaying occurs from the determining unit 5, the control unit 6 instructs the power supply unit 7 to stop the power supply to the vehicle-mounted device 1.

In addition, when acquiring response information from a wireless communication terminal via the wireless communications control unit 2a, the control unit 6 instructs the power supply unit 7 to stop the power supply to the vehicle-mounted device 1.

When the control unit 6 has not acquired any response information, the control unit determines that a wireless communication terminal carried outside the vehicle cabin moves away from the vehicle beyond the upper limit range, and selects a wireless communication method for wireless communication terminal which makes it possible to transmit the notification information beyond this upper limit range. For example, a wireless communication method which makes it possible to transmit the notification information beyond the upper limit range includes mobile data communications. Further, as a wireless communication terminal which can perform the mobile data communications, a mobile phone other than a wireless communication terminal carried into the vehicle cabin, a desktop PC (Personal Computer), or a server PC can be provided.

When the predetermined notification destination is a mobile data communication device, the control unit 6 outputs both an instruction to switch the wireless communication method to the mobile data communications, and a message for notification registered in advance to the wireless communications control unit 2a. The wireless communications control unit 2a switches to the mobile data communication unit 2e in accordance with the instruction from the control unit 6. As a result, the mobile data communication unit 2e transmits the message for notification to the mobile data communication device. After that, the control unit 6 instructs the power supply unit 7 to stop the power supply to the vehicle-mounted device 1, and the power supply unit 7 stops the power supply to the vehicle-mounted device 1.

The power supply unit 7 supplies the power to the vehicle-mounted device 1 in accordance with control by the control unit 6, as mentioned above. For example, even after the ignition key switch of the vehicle is switched off, the power supply unit 7 supplies the power to the vehicle-mounted device 1 until receiving the stop instruction from the control unit 6.

The power supply unit 7 can be a function which a device provided outside the vehicle-mounted device 1 has.

For example, the power supply unit 7 can be implemented as one function of a power supply device provided separately from the vehicle-mounted device 1. More specifically, the power supply unit 7 is not a component indispensable to the vehicle-mounted device 1 according to Embodiment 1, and thus can be omitted as appropriate.

FIG. 3 is a block diagram showing the configuration of a wireless communication terminal 8 in Embodiment 1.

The wireless communication terminal 8 is a vehicle key, a wearable terminal, a mobile phone, a tablet terminal, a mobile PC, or a smartphone, and multiple wireless communication terminals 8 can be carried inside the vehicle cabin. Further, the multiple wireless communication terminals 8 can perform wireless communications by using their respective different wireless communication methods. As functional components of the wireless communication terminal, a wireless communication unit 9, a control unit 10, a notifying unit 11, and an operation unit 12 are included.

The wireless communication unit 9 performs wireless communications with the wireless communication unit 2 of the vehicle-mounted device 1 by using the wireless communication method in the wireless communication terminal 8. The wireless communication unit 9 converts a wireless signal received from the vehicle-mounted device 1 into communication data and outputs the communication data to the control unit 10, and converts communication data destined for the vehicle-mounted device 1 into a wireless signal and transmits the wireless signal to the vehicle-mounted device 1.

When receiving the notification information which is received by the wireless communication unit 9 and which indicates the mislaying of a wireless communication terminal, the control unit 10 instructs the notifying unit 11 to provide the notification information about the mislaying of the wireless communication terminal. Further, when information indicating that the user has recognized the mislaying of the wireless communication terminal is inputted by the user using the operation unit 12, the control unit 10 instructs the wireless communication unit 9 to transmit response information indicating that the mislaying of the wireless communication terminal has been recognized to the vehicle-mounted device 1. As a result, the wireless communication unit 9 transmits the response information to the vehicle-mounted device 1.

The notifying unit 11 provides the notification information about the mislaying of the wireless communication terminal in accordance with the instruction of the control unit 10. The notification information is reported to the user by using a notifying function, such as vibration, light, sound, or display on a display, which the wireless communication terminal has. For example, the specific information, such as the model name, the owner, and the phone number of the mislaid wireless communication terminal, which is included in the notification information is displayed on the display.

The operation unit 12 receives an input operation by the user. As hardware that receives an input, a touch panel, a button, or the like is provided, and information indicating that the user has recognized the mislaying is inputted by performing an operation on the touch panel or a pressing down operation of the button.

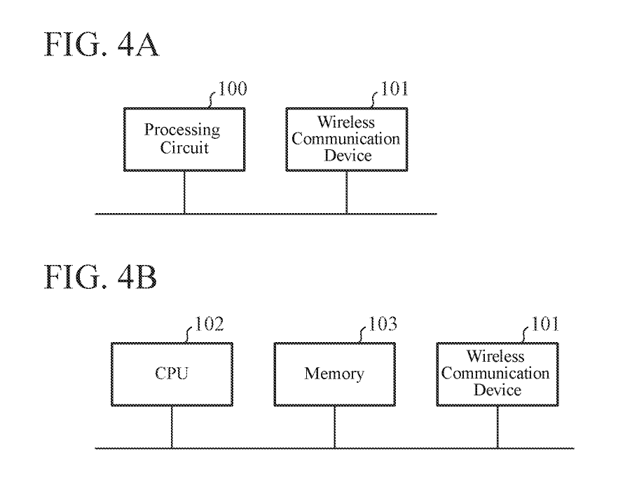

FIG. 4A is a block diagram showing an example of a hardware configuration for implementing the functions of the vehicle-mounted device 1. FIG. 4B is a block diagram showing an example of a hardware configuration for executing software to implement the functions of the vehicle-mounted device 1. The wireless communication unit 2 in the vehicle-mounted device 1 is a wireless communication device 101 shown in FIGS. 4A and 4B. More specifically, the wireless communication device 101 includes the wireless communications control unit 2a, the vehicle key communication unit 2b, the Bluetooth communication unit 2c, the Wi-Fi communication unit 2d, and the mobile data communication unit 2e, and can perform wireless communications while switching among these wireless communication methods.

Each of the functions of the estimating unit 3, the alighting detecting unit 4, the determining unit 5, the control unit 6, and the power supply unit 7 in the vehicle-mounted device 1 is implemented by a processing circuit. More specifically, the vehicle-mounted device 1 includes a processing circuit for performing these functions.

The processing circuit can be either hardware for exclusive use or a CPU (Central Processing Unit) that executes a program stored in a memory.

Similarly, the wireless communication unit 9 in the wireless communication terminal 8 shown in FIG. 3 is the wireless communication device 101 shown in FIGS. 4A and 4B, like that of the vehicle-mounted device 1. In addition, each of the functions of the control unit 10, the notifying unit 11, and the operation unit 12 in each wireless communication terminal 8 is implemented by a processing circuit.

In a case in which the above-mentioned processing circuit is one 100 shown in FIG. 4A which is hardware for exclusive use, the processing circuit 100 is, for example, a single circuit, a composite circuit, a programmable processor, a parallel programmable processor, an AISC (Application Specific Integrated Circuit), an FPGA (Field-Programmable Gate Array), or a combination of these circuits.

Each of the functions of the estimating unit 3, the alighting detecting unit 4, the determining unit 5, the control unit 6, and the power supply unit 7 in the vehicle-mounted device 1 can be implemented by a processing circuit, or the functions can be implemented collectively by a single processing circuit. Similarly, each of the functions of the wireless communication unit 9, the control unit 10, the notifying unit 11, and the operation unit 12 in the wireless communication terminal 8 can be implemented by a processing circuit, or the functions can be implemented collectively by a single processing circuit.

In a case in which the above-mentioned processing circuit is a CPU 102 shown in FIG. 4B, each of the functions of the estimating unit 3, the alighting detecting unit 4, the determining unit 5, the control unit 6, and the power supply unit 7 is implemented by software, firmware, or a combination of software and firmware. Software and firmware are described as programs and the programs are stored in a memory 103.

The CPU 102 implements each of the functions by reading and executing a program stored in the memory 103. More specifically, the vehicle-mounted device 1 includes the memory for storing programs which, when executed by the processing circuit, result in execution of the operation of each function.

Further, these programs cause a computer to perform procedures or methods which the estimating unit 3, the alighting detecting unit 4, the determining unit 5, the control unit 6, and the power supply unit 7 use.

Each of the functions of the control unit 10, the notifying unit 11, and the operation unit 12 in the wireless communication terminal 8 is implemented by either the processing circuit 100 which is hardware for exclusive use or the CPU 102, like that of the vehicle-mounted device 1.

Here, the memory is, for example, a non-volatile or volatile semiconductor memory, such as a RAM (Random Access Memory), a ROM (Read Only Memory), a flash memory, an EPROM (Erasable Programmable ROM), or an EEPROM (Electrically EPROM), a magnetic disk, a flexible disk, an optical disk, a compact disc, a mini disc, a DVD (Digital Versatile Disc), or the like.

Further, some of the functions of the estimating unit 3, the alighting detecting unit 4, the determining unit 5, the control unit 6, and the power supply unit 7 can be implemented by hardware for exclusive use, and some of the functions can be implemented by software or firmware. For example, the functions of the estimating unit 3 and the alighting detecting unit 4 are implemented by a processing circuit which is hardware for exclusive use, and the functions of the determining unit 5, the control unit 6, and the power supply unit 7 are implemented by the CPU 102's execution of a program stored in the memory 103.

In this way, the processing circuit can implement the above-mentioned functions by using hardware, software, firmware, or a combination thereof.

Similarly, some of the functions of the control unit 10, the notifying unit 11, and the operation unit 12 can be implemented by hardware for exclusive use, and some of the functions can be implemented by software or firmware.

Next, the operations will be explained.

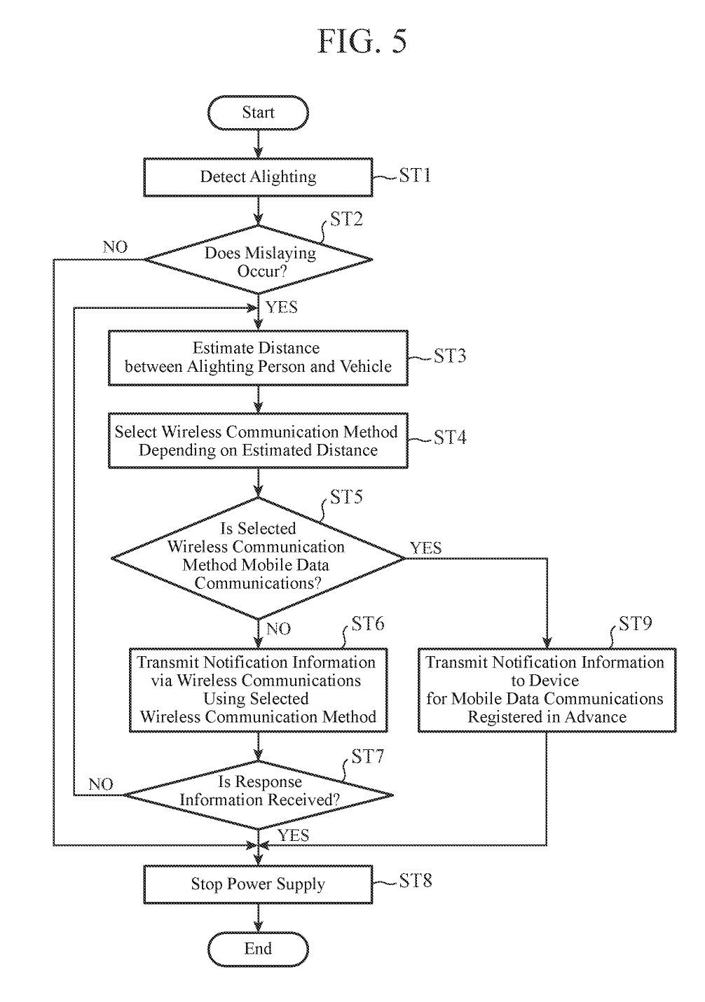

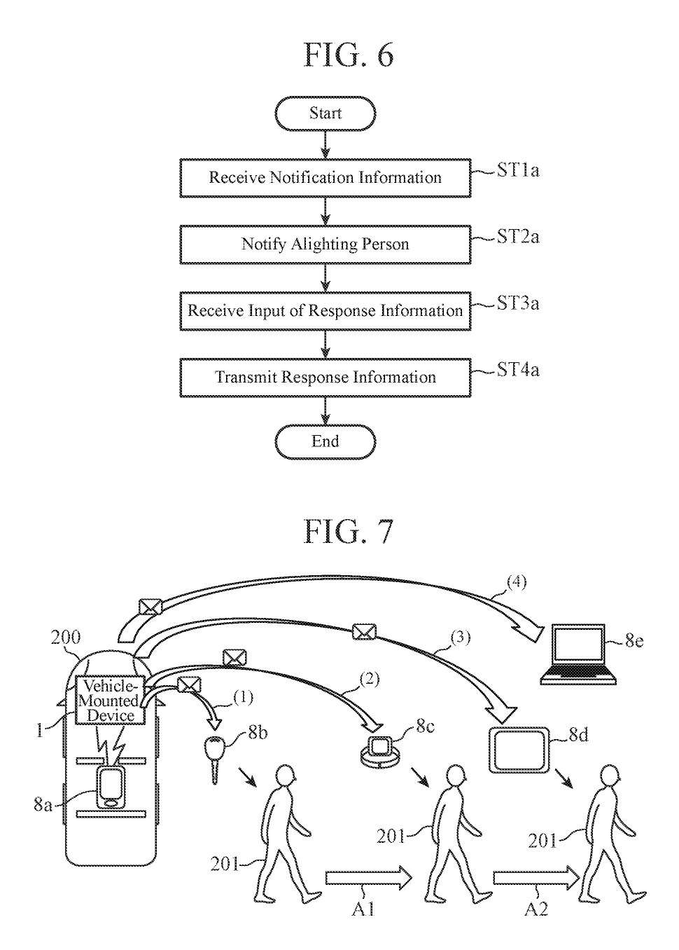

FIG. 5 is a flowchart showing the operation of the vehicle-mounted device 1, and shows a series of processes from a process of detecting the alighting of an occupant of the vehicle to a process of stopping the power supply. FIG. 6 is a flowchart showing the operations of the wireless communication terminals 8b to 8d, and shows a series of processes from a process of receiving notification information about the mislaying of the wireless communication terminal 8a to a process of transmitting response information. Further, FIG. 7 is a diagram showing a summary of a process of providing a notification of the mislaying of the wireless communication terminal 8a, and shows a case in which the wireless communication terminals 8a to 8d are carried inside the vehicle cabin and, after that, the wireless communication terminal 8a is mislaid in the vehicle cabin.

Hereafter, an explanation will be made on the assumption that the state shown in FIG. 7 occurs. Further, each of the wireless communication terminals 8a to 8e has a configuration shown in, for example, FIG. 3.

In FIG. 7, the wireless communication terminal 8a is a smartphone, the wireless communication terminal 8b is a vehicle key, the wireless communication terminal 8c is a wearable terminal, and wireless communication terminal 8d is a tablet terminal. Further, the wireless communication terminal 8e is a mobile data communication device registered in advance, and is, for example, a desktop PC that can perform wireless communications using mobile data communications.

When the wireless communication terminals 8a to 8d are carried inside the vehicle cabin, the wireless communication terminals establish wireless communications with the wireless communication unit 2 of the vehicle-mounted device 1.

For example, the wireless communication terminal 8a exchanges acknowledgements with the Bluetooth communication unit 2c in the wireless communication unit 2, thereby establishing communications. The acknowledgements are data for checking whether or not wireless communications between the wireless communication unit 2 and the wireless communication terminal 8a are established.

Similarly, the wireless communication terminal 8b establishes communications with the vehicle key communication unit 2b, the wireless communication terminal 8c establishes communications with the Bluetooth communication unit 2c, and the wireless communication terminal 8d establishes communications with the Wi-Fi communication unit 2d.

When communications are established, the wireless communication unit 2 receives specific information from each of the wireless communication terminals 8a to 8d. The specific information is the model name, the owner, the phone number, the address information, or the like of each of the wireless communication terminals 8a to 8d. The control unit 6 generates notification information about the mislaying on the basis of the specific information received by the wireless communication unit 2. The notification information has a form which makes it possible to present the notification information to the user in a wireless communication terminal using a wireless communication method selected by the control unit 6.

The estimating unit 3 in the vehicle-mounted device 1 receives the reception levels of electric waves which are received from the respective wireless communication terminals 8a to 8d by the wireless communication unit 2, and compares the reception levels inputted thereto and the data shown in FIG. 2, thereby estimating the distances between the respective wireless communication terminals 8a to 8d and the vehicle 200.

The estimation of the distances by the estimating unit 3 can be started immediately after the engine of the vehicle 200 is stopped.

Here, the explanation is returned to the explanation of FIG. 5.

In the state mentioned above, the alighting detecting unit 4 detects the alighting of an occupant after the engine of the vehicle 200 is stopped (step ST1). Detection information indicating that an occupant has alighted is outputted from the alighting detecting unit 4 to the determining unit 5.

When the alighting of an occupant is detected by the alighting detecting unit 4, the determining unit 5 determines whether or not there is a wireless communication terminal mislaid in the vehicle cabin, out of the wireless communication terminals 8a to 8d which have been carried inside the vehicle cabin (step ST2). For example, the determining unit 5 determines that a wireless communication terminal of which the above-mentioned corresponding distance estimated by the estimating unit 3 has not changed is a wireless communication terminal mislaid in the vehicle cabin.

When it is determined that there is no wireless communication terminal mislaid in the vehicle cabin (NO in step ST2), the processing proceeds to a process of step ST8.

When receiving a notification indicating that no mislaying occurs from the determining unit 5, the control unit 6 instructs the power supply unit 7 to stop the power supply to the vehicle-mounted device 1. As a result, the power supply unit 7 stops the power supply to the vehicle-mounted device 1 (step ST8).

In contrast, when it is determined that there is a wireless communication terminal mislaid in the vehicle cabin (YES in step ST2), the determining unit 5 outputs both a result of the determination of the mislaying and the specific information about the mislaid wireless communication terminal to each of the estimating unit 3 and the control unit 6. Here, it is assumed that the wireless communication terminal 8a is mislaid in the vehicle cabin.

When receiving the specific information about the wireless communication terminal 8a mislaid in the vehicle cabin from the determining unit 5, the estimating unit 3 estimates the distance between the alighting person 201 who has carried out the wireless communication terminals 8b to 8d, other than the wireless communication terminal 8a, outside the vehicle cabin, and the vehicle 200 (step ST3). Here, it is assumed that the distance between the vehicle 200 and the alighting person 201 is equal to the distance between each of the wireless communication terminals 8b to 8d and the vehicle 200.

The control unit 6 selects a wireless communication method at the time that the wireless communication unit 2 transmits the notification information, depending on the above-mentioned distance estimated by the estimating unit 3 (step ST4).

For example, when the wireless communication terminal 8b which is the vehicle key is carried outside the vehicle cabin, the control unit 6 determines that the driver of the vehicle 200 is the alighting person 201 and selects the vehicle key communications (1) first. At this time, the control unit 6 checks whether the control unit has selected the mobile data communications from among the wireless communication methods with each of which the wireless communication unit 2 can perform wireless communications (step ST5).

When the vehicle key communications are selected (NO in step ST5), the control unit 6 provides an instruction to switch to the vehicle key communication unit 2b for the wireless communications control unit 2a. For example, the control unit 6 outputs both the instruction to switch the wireless communication method to the vehicle key communications, and the notification information about the mislaying to the wireless communications control unit 2a. Both information reporting the mislaying of the wireless communication terminal 8a, and the specific information about the wireless communication terminal 8a are included in the notification information, as mentioned above. As the specific information about the wireless communication terminal 8a, at least one of the identification information such as the model name of the wireless communication terminal 8a, the owner information, and the phone number can be provided. The wireless communications control unit 2a switches to the vehicle key communication unit 2b in accordance with the instruction from the control unit 6, and the vehicle key communication unit 2b transmits the notification information to the vehicle key (step ST6).

In step 1a of FIG. 6, the wireless communication unit 9 of the wireless communication terminal 8b receives the notification information from the vehicle key communication unit 2b. The wireless communication unit 9 outputs the notification information received thereby to the control unit 10. When receiving the notification information about the mislaying of the wireless communication terminal 8a, the control unit 10 instructs the notifying unit 11 to provide the notification information. As a result, the notifying unit 11 notifies the alighting person 201 of both the information indicating that the wireless communication terminal 8a is mislaid and the specific information about the wireless communication terminal 8a, by using a visual or auditory method (step ST2a). For example, as the visual method, display on a display is provided, and, as the auditory method, sound output from a speaker is provided.

When the notification information is provided by the notifying unit 11, the operation unit 12 receives an input operation indicating that the mislaying of the wireless communication terminal 8a has been recognized (step ST3a).

When information indicating that the alighting person 201 has recognized the mislaying of the wireless communication terminal 8a is inputted by the alighting person using the operation unit 12, the operation unit 12 outputs this operation information to the control unit 10.

When the above-mentioned operation information is inputted from the operation unit 12, the control unit 10 instructs the wireless communication unit 9 to transmit response information to the vehicle-mounted device 1. The wireless communication unit 9 transmits the response information to the vehicle-mounted device 1 in accordance with the instruction of the control unit 10 (step ST4a). The response information indicates that the mislaying of the wireless communication terminal 8a has been recognized.

The explanation is returned to the explanation of FIG. 5. The control unit 6 of the vehicle-mounted device 1 causes the wireless communication unit 2 to repeatedly perform the transmission of the above-mentioned notification information at fixed intervals, and check whether or not response information is received while the transmission is performed a predetermined number of times (step ST7). By repeatedly performing the transmission of the notification of the mislaying until response information is received, the opportunity to provide a notification of the mislaying of the wireless communication terminal 8a can be increased, and, as a result, the opportunity that the alighting person 201 notices is increased.

When receiving response information from the wireless communication terminal 8b (YES in step ST7), the wireless communication unit 2 outputs the response information to the control unit 6.

When receiving the response information, the control unit 6 instructs the power supply unit 7 to stop the power supply to the vehicle-mounted device 1. As a result, the power supply unit 7 stops the power supply to the vehicle-mounted device 1 (step ST8).

Hereafter, a case in which the alighting person 201 moves in a direction A1 away from the vehicle 200 without noticing the notification which has been provided for the wireless communication terminal 8b the above-mentioned number of times is taken as an example.

In this case, because no response information is received (NO in step ST7), the processing returns to the process of step ST3. When the distance estimated by the estimating unit 3 falls within the range of 1 m to 3 m from the vehicle, the control unit 6 selects the Bluetooth communications (2) and instructs the wireless communications control unit 2a to switch to the Bluetooth communication unit 2c.

The wireless communications control unit 2a switches to the Bluetooth communication unit 2c in accordance with the instruction from the control unit 6, and the Bluetooth communication unit 2c transmits the notification information to the wireless communication terminal 8c which is a wearable terminal.

A case in which the alighting person 201 further moves in a direction A2 away from the vehicle 200 without noticing the notification which has been provided for the wireless communication terminal 8c the above-mentioned number of times is taken as an example.

Also in this case, because no response information is received (NO in step ST7), the processing returns to the process of step ST3. When the distance estimated by the estimating unit 3 falls within the range of 3 m to 5 m from the vehicle, the control unit 6 selects the Wi-Fi communications (3) and instructs the wireless communications control unit 2a to switch to the Wi-Fi communication unit 2d. The wireless communications control unit 2a switches to the Wi-Fi communication unit 2d in accordance with the instruction of the control unit 6, and the Wi-Fi communication unit 2d transmits the notification information to the wireless communication terminal 8d which is a tablet terminal.

In addition, a case in which the alighting person 201 moves beyond the upper limit range from the vehicle 200 without noticing the notification which has been provided for the wireless communication terminal 8d the above-mentioned number of times is taken as an example. For example, the upper limit range is a range of 5 m or more.

In step ST3, the estimating unit 3 estimates that a distance from the alighting person 201 to the vehicle 200 exceeds the upper limit range. When the distance estimated by the estimating unit 3 exceeds the upper limit range, the control unit 6 selects the mobile data communications (4) (YES in step ST5) and instructs the wireless communications control unit 2a to switch to the mobile data communication unit 2e.

The wireless communications control unit 2a switches to the mobile data communication unit 2e in accordance with the instruction of the control unit 6. The mobile data communication unit 2e transmits the notification information to the wireless communication terminal 8e which is a mobile data communication device registered in advance (step ST9).

As the mobile data communication device, a device with which the alighting person 201 can likely recognize the notification information is registered. For example, the mobile data communication device can be a mobile phone possessed by the family of the alighting person 201 or a PC provided in the home of the alighting person 201.

By transmitting the notification information to the notification destination registered in advance in this way, the possibility that the alighting person 201 can recognize the notification information can be improved even when the alighting person 201 does not notice the notification for each wireless communication terminal carried by the alighting person 201.

As mentioned above, in the vehicle-mounted device 1 according to Embodiment 1, when it is determined by the determining unit 5 that the wireless communication terminal 8a is mislaid, the control unit 6 selects a wireless communication method from among the multiple wireless communication methods depending on the degrees that the wireless communication terminals 8b to 8d move away from the vehicle. The wireless communication unit 2 transmits notification information about the mislaying to a wireless communication terminal outside the vehicle cabin via wireless communications using the wireless communication method selected by the control unit 6.

Particularly, the estimating unit 3 estimates the distances between the respective wireless communication terminals 8b to 8d and the vehicle 200, and the control unit 6 selects a wireless communication method at the time that the wireless communication unit 2 transmits the notification information, depending on the distances estimated by the estimating unit 3. The wireless communication unit 2 transmits the notification information about the mislaying via wireless communications using the wireless communication method selected from among the multiple wireless communication methods.

In this way, the selection of a wireless communication method is repeated among the multiple wireless communication methods, depending on the degrees that the respective wireless communication terminals 8b to 8d move away from the vehicle 200, such as the distances between the respective wireless communication terminals 8b to 8d and the vehicle, and a notification of the mislaying is provided via wireless communications using the selected wireless communication method. As a result, the opportunity to provide a notification of the mislaying of the wireless communication terminal 8a can be increased.

Further, in the vehicle-mounted device 1 according to Embodiment 1, the control unit 6 first selects the wireless communication method of the vehicle key from among the multiple wireless communication methods, as the wireless communication method at the time that the wireless communication unit 2 transmits the notification information. As a result, the driver who is the alighting person can be promptly notified of the mislaying of the wireless communication terminal 8a.

In addition, in the vehicle-mounted device 1 according to Embodiment 1, until response information to the notification information about the mislaying is received, both the selection of a wireless communication method by the control unit 6, and the transmission of the notification information by the wireless communication unit 2 via wireless communications using the selected wireless communication method are repeatedly performed.

By constituting in this way, the opportunity to provide a notification of the mislaying of the wireless communication terminal 8a can be increased, and, as a result, the opportunity that the alighting person 201 notices is increased.

In addition, in the vehicle-mounted device 1 according to Embodiment 1, when the wireless communication terminals 8b to 8d move away from the vehicle 200 beyond the upper limit range, the control unit 6 selects a wireless communication method for wireless communication terminal which makes it possible to transmit the notification information beyond the upper limit range. By constituting in this way, the possibility that the alighting person 201 can recognize the notification information can be increased.

It is to be understood that various changes can be made in any component according to the embodiment, or any component according to the embodiment can be omitted within the scope of the invention.

### INDUSTRIAL APPLICABILITY

Because the vehicle-mounted device according to the present invention can increase the opportunity to provide a notification of the mislaying of a wireless communication terminal, the vehicle-mounted device is suitable for, for example, a device for preventing the mislaying of a mobile phone or the like.

### REFERENCE SIGNS LIST

1 vehicle-mounted device, 2, 9 wireless communication unit, 2a wireless communications control unit, 2b vehicle key communication unit, 2b-1, 2c-1, 2d-1, 2e-1 antenna, 2c Bluetooth communication unit, 2d Wi-Fi communication unit, 2e mobile data communication unit, 3 estimating unit, 4 alighting detecting unit, 5 determining unit, 6, 10 control unit, 7 power supply unit, 8, 8a to 8e wireless communication terminal, 11 notifying unit, 12 operation unit, 100 processing circuit, 101 wireless communication device, 102 CPU, 103 memory, 200 vehicle, and 201 alighting person.

1. A vehicle-mounted device comprising:
a processor to execute a program; and
a memory to store the program which, when executed by the processor, performs processes of,
estimating degrees that respective one or more wireless communication terminals move away from a vehicle;
detecting alighting of an occupant of the vehicle;
when alighting of the occupant is detected, determining whether or not there is a wireless communication terminal mislaid in a vehicle cabin of the vehicle, out of the wireless communication terminals whose degrees that the respective wireless communication terminals move away from the vehicle are estimated;
performing wireless communications while switching among different multiple wireless communication methods, and, when it is determined that there is a wireless communication terminal mislaid in the vehicle cabin, transmitting notification information about the mislaying to a wireless communication terminal outside the vehicle cabin via wireless communications using a wireless communication method selected from among the multiple wireless communication methods; and
selecting one of the wireless communication methods at a time transmitting the notification information, depending on the degrees that the respective wireless communication terminals move away from the vehicle, the degrees being estimated.

2. The vehicle-mounted device according to claim 1, wherein the processes include estimating distances between the respective wireless communication terminals and the vehicle, and selecting one of the wireless communication methods at a time of transmitting the notification information, depending on the distances estimated.

3. The vehicle-mounted device according to claim 1, wherein the processes include first selecting, as a wireless communication method at a time of transmitting the notification information, a wireless communication method of a vehicle key from among the multiple wireless communication methods.

4. The vehicle-mounted device according to claim 1, wherein, until response information to the notification information about the mislaying is received, both the selection of one of the wireless communication methods, and the transmission of the notification information via wireless communications using the selected wireless communication method are repeatedly performed.

5. The vehicle-mounted device according to claim 1, wherein the processes include, when one of the wireless communication terminals moves away from the vehicle beyond an upper limit range, selecting a wireless communication method for wireless communication terminal which makes it possible to transmit the notification information beyond the upper limit range, from among the wireless communication methods.

6. A notification system comprising:
the vehicle-mounted device according to claim 1;
a wireless communication terminal to transmit response information to the notification information about the mislaying to the vehicle-mounted device, the notification information being received from the vehicle-mounted device.

7. A notification method comprising:
estimating degrees that respective one or more wireless communication terminals move away from a vehicle;
detecting alighting of an occupant of the vehicle;
when alighting of the occupant is detected, determining whether or not there is a wireless communication terminal mislaid in a vehicle cabin of the vehicle, out of the wireless communication terminals whose degrees that the respective wireless communication terminals move away from the vehicle are estimated;
when it is determined that there is a wireless communication terminal mislaid in the vehicle cabin, selecting a wireless communication method from among different multiple wireless communication methods, depending on the degrees that the respective wireless communication terminals move away from the vehicle, the degrees being estimated; and
switching to wireless communications using the wireless communication method selected, and transmitting notification information about the mislaying to a wireless communication terminal outside the vehicle cabin.
